(19) United States
(12) Patent Application Publication
(10) Pub. No.: US 2017/0024197 A1
(43) Pub. Date: Jan. 26, 2017

(54) APPARATUS, SYSTEM AND METHOD OF DOWNLOADING FIRMWARE FROM A MOBILE DEVICE TO A DOCKING DEVICE

(71) Applicants: Paz PENTELKA, Netanya (IL); Elad LEVY, Rishon LeZion (IL); Eytan MANN, Modiin (IL); Michael GLIK, Kfar Saba (IL); Tal DAVIDSON, Holon (IL)

(72) Inventors: Paz PENTELKA, Netanya (IL); Elad LEVY, Rishon LeZion (IL); Eytan MANN, Modiin (IL); Michael GLIK, Kfar Saba (IL); Tal DAVIDSON, Holon (IL)

(73) Assignee: INTEL IP CORPORATION, Santa Clara, CA (US)

(21) Appl. No.: 15/038,823

(22) PCT Filed: Dec. 24, 2013
(86) PCT No.: PCT/US2013/077674

§ 371 Date: May 24, 2016

(51) Int. Cl. G06F 9/445; G06F 13/42

(52) U.S. Cl. CPC G06F 8/61; G06F 9/44505; G06F 13/4286

(57) ABSTRACT

Some demonstrative embodiments include apparatuses, systems and/or methods of downloading firmware from a mobile device to a docking device. For example, an apparatus may include a docking controller to control a wireless communication unit of a mobile device to communicate with a docking device over a wireless communication link between the mobile device and the docking device, wherein the docking controller is to download a device-specific docking firmware from the mobile device to the docking device via the wireless communication link, the device-specific docking firmware is to control interaction between the docking device and the mobile device according to a configuration of the mobile device.

### TECHNICAL FIELD

Embodiments described herein generally relate to downloading firmware from a mobile device to a docking device.

### BACKGROUND

Mobile platforms are becoming smaller and smaller, and typically have decreasingly smaller screens and less Input/Output (IO) ports from generation to generation.

Docking stations are commonly used nowadays to extend the IO port array of the mobile platforms, and provide a convenient means for a mobile platform to hook up to a static variety of peripheral devices (“peripherals”), such as displays, monitors, external storage devices, external Hard Disk Drives (HDD), a mouse, keyboards, webcams, communication devices, and the like.

A docking device (also referred to as “docking station”) may typically be placed on a table, while being permanently connected to the peripherals, and the user may connect the mobile platform to the docking station (“dock”) to utilize the peripherals.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic flow chart illustration of a method of downloading a firmware from a mobile device to a docking device, in accordance with some demonstrative embodiments.

FIG. 3 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, an Ultrabook™ computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AN) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11 task group ac (TGac) (“IEEE802.11-09/0308r12—TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing and/or Wireless Fidelity (WiFi) Alliance (WFA) Peer-to-Peer (P2P) specifications (WiFi P2P technical specification, version 1.2, 2012), and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

The term “downloading” as used herein with respect to an element includes sending the element and/or receiving the element. For example, a device, which is capable of downloading firmware, may send the firmware to at least one other device, and/or may receive the firmware from at least one other device. The verb downloading may be used to refer to the action of sending or the action of receiving. In one example, the phrase “downloading firmware” may refer to the action of sending the firmware by a first device, and may not necessarily include the action of receiving the firmware by a second device. In another example, the phrase “downloading firmware” may refer to the action of receiving the firmware by a first device, and may not necessarily include the action of sending the firmware by a second device.

Some demonstrative embodiments may be used in conjunction with a WLAN. Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

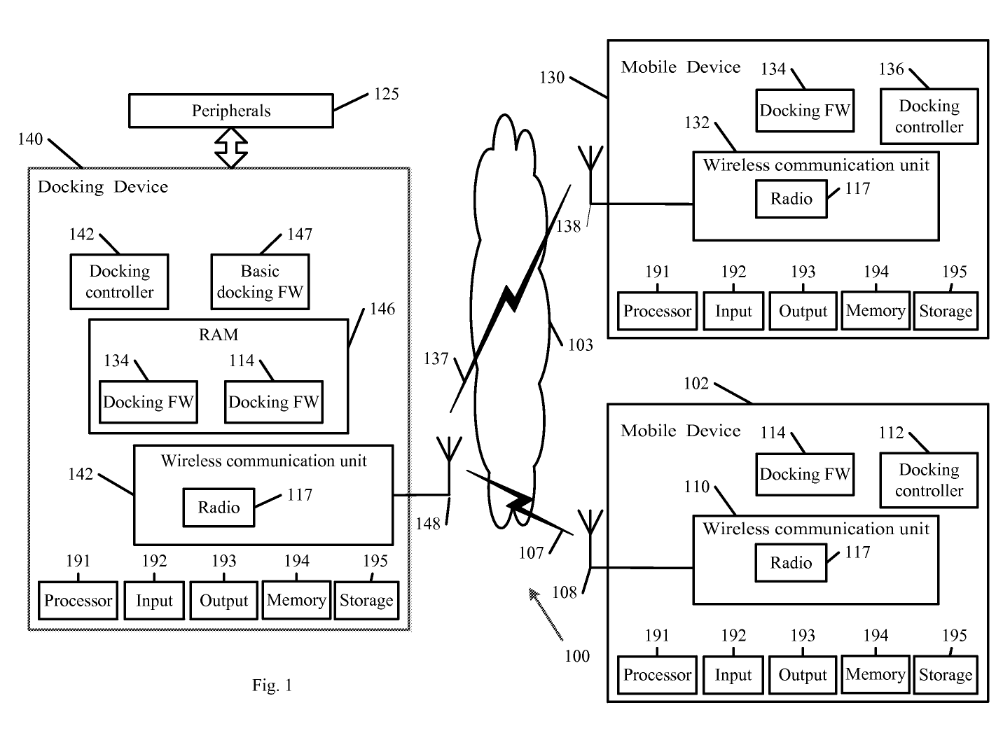

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information and/or signals via a wireless medium (WM) 103. For example, system 100 may include a wireless communication device 102, a wireless communication device 130, and a wireless communication device 140.

In some demonstrative embodiments, wireless medium 103 may include, for example, a radio channel, a cellular channel, an RF channel, a Wireless Fidelity (WiFi) channel, an IR channel, and the like. One or more elements of system 100 may optionally be capable of communicating over any suitable wired communication links.

In some demonstrative embodiments, devices 102, 130 and/or 140 may include one or more wireless communication units to perform wireless communication between device 102, device 130, device 140, and/or one or more other wireless communication devices. For example, device 102 may include a wireless communication unit 110, device 130 may include a wireless communication unit 132, and/or device 140 may include a wireless communication unit 142.

In some demonstrative embodiments, wireless communication units 110, 132 and/or 142 may include one or more radios 117, e.g., including one or more wireless transmitters, receivers and/or transceivers able to send and/or receive wireless communication signals, RF signals, frames, blocks, transmission streams, packets, messages, data items, and/or data. In one example, the radios may include modulation elements, demodulation elements, amplifiers, analog to digital and digital to analog converters, filters, and/or the like. For example, wireless communication units 110, 132 and/or 142 may include or may be implemented as part of a wireless Network Interface Card (NIC), and the like.

In some demonstrative embodiments, wireless communication units 110, 132, and/or 142 may include, or may be associated with, one or more antennas. For example, wireless communicate unit 110 may be associated with one or more antennas 108, wireless communicate unit 132 may be associated with one or more antennas 138, and/or wireless communicate unit 142 may be associated with one or more antennas 148.

Antennas 108, 138, and/or 148 may include any type of antennas suitable for transmitting and/or receiving wireless communication signals, blocks, frames, transmission streams, packets, messages and/or data. For example, antennas 108, 138, and/or 148 may include any suitable configuration, structure and/or arrangement of one or more antenna elements, components, units, assemblies and/or arrays. Antennas 108, 138, and/or 148 may include, for example, antennas suitable for directional communication, e.g., using beamforming techniques. For example, antennas 108, 138, and/or 148 may include a phased array antenna, a multiple element antenna, a set of switched beam antennas, and/or the like. In some embodiments, antennas 108, 138, and/or 148 may implement transmit and receive functionalities using separate transmit and receive antenna elements. In some embodiments, antennas 108, 138, and/or 148 may implement transmit and receive functionalities using common and/or integrated transmit/receive elements.

In some demonstrative embodiments, devices 102, 130 and/or 140 may also include, for example, a processor 191, an input unit 192, an output unit 193, a memory unit 194, and a storage unit 195. Devices 102, 130 and/or 140 may optionally include other suitable hardware components and/or software components. In some demonstrative embodiments, some or all of the components of devices 102, 130 and/or 140 may be enclosed in a common housing or packaging, and may be interconnected or operably associated using one or more wired or wireless links. In other embodiments, components of devices 102, 130 and/or 140 may be distributed among multiple or separate devices.

Processor 191 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of device 102 and/or of one or more suitable applications.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by device 102.

Input unit 192 includes, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Cathode Ray Tube (CRT) display unit, a Liquid Crystal Display (LCD) display unit, a plasma display unit, one or more audio speakers or earphones, or other suitable output devices.

In some demonstrative embodiments, device 102 and/or device 130 may include a mobile device.

In some demonstrative embodiments, device 102 and/or device 130 may include, for example, a User Equipment (UE), a mobile computer, a laptop computer, a notebook computer, a tablet computer, an Ultrabook™ computer, a mobile intern& device, a handheld computer, a handheld device, a storage device, a PDA device, a handheld PDA device, an on-board device, an off-board device, a hybrid device, a consumer device, a vehicular device, a non-vehicular device, a portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), an “Origami” device or computing device, a video device, an audio device, an A/V device, a gaming device, a media player, a Smartphone, or the like.

In some demonstrative embodiments, device 140 may include a docking device connected to one or more peripherals 125. For example, peripherals 125 may include, for example, a display, a keyboard, a mouse, one or more speakers, a Universal Serial Bus (USB) hub, an external storage, and/or the like.

In some demonstrative embodiments, docking device 140 may be configured to provide one or more functionalities to a mobile wireless device, e.g., devices 102 and/or 130, in a wireless manner. For example, device 140 may enable the mobile wireless device to utilize peripherals 125 and to use one or more functionalities associated with peripherals 125 in a wireless manner. For example, devices 102 and/or 130 may be able to utilize an external display, e.g., to display video content, and to utilize one or more functionalities of the display, e.g., to adjust one or more picture attributes, for example, a color, a brightness and/or a hue.

In some demonstrative embodiments, peripherals 125 may be implemented as part of docking device 140. For example, docking device 140 may include a wireless display.

In other embodiments, peripherals 125 may be implemented as a separate element, which is connected to docking device 140. For example, docking device 140 may include a wireless docking station and peripherals 125 may include an external storage device connected to the wireless docking station.

In some demonstrative embodiments, wireless communication units 110 and 142 may be configured to establish a wireless communication link 107 between device 102 and docking device 140 over WM 103. For example, wireless communication units 110 and 142 may establish wireless communication link 107 to enable device 102 to utilize the one or more functionalities of peripherals 125.

In one example, docking device 140 may include a wireless display and device 102 may include a Smartphone. Wireless communication units 110 and 142 may establish wireless communication link 107, to enable a user of device 102 to display video from the Smartphone on the wireless display.

In some demonstrative embodiments, wireless communication link 107 may include a millimeter-wave (mmwave) wireless communication link.

In some demonstrative embodiments, wireless communication link 107 may include a peer-to-peer (P2P) communication link.

In other embodiments, wireless communication link 107 may include any other wireless communication link.

In some demonstrative embodiments, device 140 may not be able to provide the one or more functionalities of device 140 to device 102, for example, if device 140 does not have a suitable docking firmware (FW) for device 102.

For example, the Smartphone may not be able to utilize one or more functionalities of the wireless display, e.g., to control the wireless display, for example, if the wireless display does not have docking FW configured to interact with the Smartphone.

In some demonstrative embodiments, a docking firmware for a mobile device may include a software module including code and/or data configured to control an interaction between a docking device and the mobile device according to a configuration of the mobile device. Controlling the interaction between a docking device and the mobile device according to a configuration of the mobile device may include any one or more operations and/or functionalities of controlling, managing, modifying and/or adjusting an interaction between the docking device and the mobile device according to the configuration of the mobile device. For example, the configuration of the mobile device may include a configuration, specification, version, and/or design of one or more attributes of the mobile device. For example, the configuration of the mobile device may include a specification of the mobile device, a software version of the mobile device, a hardware design of the mobile device, a user interface of the mobile device, and/or one or more other attributes of the mobile device.

In some demonstrative embodiments, the docking firmware for device 102 may control an interaction between device 102 and docking device 140 according to a configuration of device 102.

In some demonstrative embodiments, the docking firmware for device 102 may control one or more interaction attributes with respect to the interaction between device 102 and docking device 140.

In one example, the one or more interaction attributes may include a communication protocol to communicate between docking device 140 and device 102. For example, the communication protocol may include a P2P communication protocol, a version of the P2P communication protocol, or any other communication protocol attribute.

In another example, the one or more interaction attributes may include a type of information to be communicated between docking device 140 and device 102. For example, the type of information may include video, audio, data, and/or any other type of information.

In another example, the one or more interaction attributes may include connection management of wireless communication link 107, access management of wireless communication link 107, time management of wireless communication link 107, power management of the communication over wireless communication link 107, and/or any other attribute of wireless communication link 107.

In another example, the one or more interaction attributes may include any other attributes configured to manage, control, define, modify and/or adjust the interaction between device 102 and docking device 140.

In some demonstrative embodiments, device 140 may not have the docking firmware for device 102, for example, if device 140 does not store, e.g., in storage 195, the docking FW for device 102.

In some demonstrative embodiments, device 140 may not have the docking firmware for device 102, for example, if device 140 does not have a current version of the docking FW for device 102.

In some demonstrative embodiments, device 140 may not have the docking firmware for device 102, for example, if a docking FW for device 102 stored in storage 195 is corrupted. In other embodiments, device 140 may not have the docking firmware for device 102 for any other reason.

In some demonstrative embodiments, different devices, e.g., having different configurations, may require the use of different docking firmware. For example, a first device may have a first docking firmware to control interaction between the first device and a docking device, and a second device, e.g., having a different configuration from the configuration of the first device, may have a second docking firmware, e.g., different from the first docking FW, to control interaction between the second device and the docking device.

For example, the docking firmware for device 102 may be different from a docking firmware for device 130, for example, if device 130 has a different configuration from device 102.

In some demonstrative embodiments, device 140 may be required to store a relatively large number of different docking firmware, for example, to enable different devices to interact with docking device 140.

In some demonstrative embodiments, storing the different docking firmware may require device 140 to have a relatively large storage and/or to be updated in a relatively frequent manner, e.g., to enable device 140 to use a current and/or up-to date version of the firmware.

In some demonstrative embodiments, storing and handling the different docking firmware may be relatively complex, for example, due to a complexity of supporting and validating different versions of the different docking firmware and/or due to a growing number of different new devices and associated docking firmware for the new devices.

In one example, docking devices and/or mobile devices may be produced and/or supplied separately, for example, on different timelines and/or by different vendors. Accordingly, a software running on a mobile device, e.g., an OS of the mobile device, and a docking firmware running on the docking device may not be compatible, for example, as a result of a version mismatch. A complexity of supporting and validating different mobile devices with different docking firmware may increase significantly, for example, when more devices having different software and more docking stations having different docking firmware are released to the market.

Some demonstrative embodiments may enable device 140 to interact with a mobile device and to store only a current version of a docking firmware for the device, e.g., while interacting with the device. For example, device 140 may not store any other docking firmware for other devices, for example, which are not interacting with docking device 140, e.g., as described below. In other embodiments, device 140 may concurrently store a plurality of firmware, fir example, for a plurality of mobile devices.

Some demonstrative embodiments may enable device 140 to wirelessly download the docking firmware for the device, for example, upon establishing a wireless connection with the device. For example, device 140 may wirelessly download the docking firmware for device 102 upon establishing a connection with device 102, e.g., as described below.

In some demonstrative embodiments, device 102 may include a docking controller 112 to control wireless communication unit 110 to establish wireless communication link 107 over WM 103 to communicate and/or to interact with docking device 140.

In some demonstrative embodiments, docking device 140 may include a docking controller 142 to control wireless communication unit 142 to establish wireless communication link 107 over WM 103 to communicate and/or to interact with mobile device 102.

In some demonstrative embodiments, device 140 may include a basic, e.g., limited, firmware 147 configured to enable device 140 to control basic and/or limited interaction with one or more devices.

In some demonstrative embodiments, basic software 147 may include a general firmware, which may be configured to enable device 140 to control basic and/or limited interaction for a relatively large number, of different mobile devices. Basic software may consume a relatively reduced capacity of storage.

In some demonstrative embodiments, basic firmware 147 may enable wireless communication unit 142 to establish wireless communication link 107 with device 102.

In some demonstrative embodiments, basic firmware 147 may enable wireless communication unit 142, for example, to download a docking firmware for device 102 via wireless communication link 107.

In some demonstrative embodiments, basic firmware 147 may enable wireless communication unit 142, for example, to verify and/or authenticate the docking firmware for device 102, e.g., prior to downloading the docking firmware from device 102.

In some demonstrative embodiments, basic firmware 147 may not enable and/or allow other actions and or interactions between device 102 and 140. For example, basic firmware 147 may not enable device 102 to utilize peripherals 125, e.g., prior to downloading the firmware of device 102.

In some demonstrative embodiments, device 102 may include a device-specific docking firmware 114 configured to control interaction between a docking station, e.g., device 140, and device 102 according to the configuration of device 102, e.g., as described above.

In some demonstrative embodiments, device-specific docking firmware 114 may be stored in a non-volatile storage of device 102, for example, in storage unit 194. In other embodiments, device-specific docking firmware 114 may be stored in another non-volatile storage of device 140, e.g., a flash memory of device 102.

In some demonstrative embodiments, device-specific docking firmware 114 may control one or more interaction attributes with respect to the interaction between device 102 and docking device 140.

In one example, the one or more interaction attributes may include a communication protocol to communicate between docking device 140 and device 102. For example, the communication protocol may include a version of a particular P2P communication protocol utilized for communication by device 102.

In another example, the one or more interaction attributes may include a type of information to be communicated between docking device 140 and device 102. in one example, a first device-specific docking firmware 114 may configured to control transfer of video from device 102 to docking device 104, while a second device-specific docking firmware 114 may configured to control transfer of audio from device 102 to docking device 104.

In another example, the one or more interaction attributes may include connection management of wireless communication link 107, access management of wireless communication link 107, time management of wireless communication link 107 and/or power management of the communication over wireless communication link 107. For example, device-specific docking firmware 114 may configured to implement a particular connection management scheme, a particular access management scheme, and/or a particular power management scheme, which may be configured base don one or more particular configuration attributes of device 102.

In another example, the one or more interaction attributes may include any other attributes configured to manage, control, modify and/or adjust the interaction between device 102 and docking device 140, e.g., according to a particular configuration of device 102.

In some demonstrative embodiments, docking controller 112 may download device-specific docking firmware 114 from device 102 to docking device 140 via wireless communication link 107, for example, upon establishing wireless communication link 107.

In some demonstrative embodiments, docking controller 142 may receive the download of the device-specific docking firmware 114 via wireless communication link 107.

In some demonstrative embodiments, docking device 140 may include a Random Access Memory (RAM) 146 to store device-specific docking firmware 114.

In some demonstrative embodiments, RAM 146 may be part of memory unit 194. In other embodiments, RAM 146 may be part of wireless communication unit 110, e.g., as part of the NIC of docking device 140.

In some demonstrative embodiments, processor 191 of docking device 140 may execute device-specific docking firmware 114 to control the interaction between docking device 140 and mobile device 102.

In some demonstrative embodiments, docking controller 142 may re-download device-specific docking firmware 114 via wireless communication link 107 responsive to a power cycle of docking device 140.

In one example, docking device 140 may experience a power cycle, for example, as a result of a crash of device 140, a boot of device 140, resetting of device 140 by a user of device 140, and/or for any other reason. As a result, device-specific docking firmware 114 may be erased from RAM 146. Accordingly, docking controller 142 and/or 112 may re-download device-specific docking firmware 114 from device 102, for example, to enable docking device 140 to continue to interact with mobile device 102.

In some demonstrative embodiments, docking device 140 and/or mobile device 102 may disconnect from each other, for example, if mobile device 102 completes to utilize the functionalities of docking device 140. For example, the Smartphone may disconnect from the wireless display, for example, if a user of the Smartphone completes to display video from the Smartphone on the wireless display.

In some demonstrative embodiments, docking controller 142 may remove device-specific docking firmware 114 from RAM 146, for example, if docking device 140 disconnects from mobile device 102.

In some demonstrative embodiments, docking controller 112 may update device-specific docking firmware 114, e.g., which may be stored in storage 194 of device 102, based on an updated device-specific docking firmware received from a vendor of device 102. For example, docking controller 112 may update device-specific docking firmware 114, for example, if the vendor of the Smartphone releases a new version of device-specific docking firmware 114.

In some demonstrative embodiments, docking controller 142 may re-download device-specific docking firmware 114 via wireless communication link 107, for example, if docking controller 112 updates device-specific docking firmware 114.

In some demonstrative embodiments, device 140 may be able to interact with another mobile device, for example, by downloading a device-specific firmware for the another device.

In some demonstrative embodiments, device 140 may interact with mobile device 130, e.g., by downloading a device-specific firmware for device 130.

In some demonstrative embodiments, device 140 may interact with mobile devices 130 and 102 during separate time periods. For example, docking device 140 may interact with mobile device 102 to display video from the Smartphone on the wireless display. Device 140 may disconnect from device 102. Device 130 may include, for example, a tablet, and docking device 140 may download the device-specific firmware for device 130 to interact with device 130, for example, to display video from the tablet on the wireless display.

In other embodiments, device 140 may simultaneously interact with two or more mobile devices, for example, by downloading a device-specific firmware for each of the mobile devices. For example, device 140 may simultaneously interact with a first device and a second device, for example, by connecting to the first device and downloading a device-specific firmware for the first device, and by connecting to the second device and downloading a device-specific firmware for the second device.

In some demonstrative embodiments, device 140 may simultaneously interact with mobile device 130 and mobile device 102. For example, device 140, may simultaneously display video from the Smartphone and video from the tablet.

In some demonstrative embodiments, device 130 may include a docking controller 136 to control interaction between device 130 and a docking device, e.g., docking device 140.

In some demonstrative embodiments, docking controller 136 may control wireless communication unit 132 to establish a wireless communication link 137 over WM 103 to communicate and/or to interact with docking device 140, for example, to enable mobile device 130 to utilize peripherals 125.

In some demonstrative embodiments, wireless communication units 142 and 132 may establish wireless communication link 137, for example, by utilizing basic firmware 147, e.g., as described above.

In some demonstrative embodiments, docking controller 142 may connect to mobile device 130 upon disconnection of docking device 140 from device 102. In other embodiments, docking controller 142 may connect to mobile device 130, for example, while device 102 is still connected to docking device 140.

In some demonstrative embodiments, device 130 may include a device-specific docking firmware 134 configured to control interaction between a docking station, e.g., device 140, and device 130 according to the configuration of device 130, e.g., as described above.

In some demonstrative embodiments, device-specific docking firmware 134 may be stored in a non-volatile storage of device 130, for example, in storage unit 194.

In some demonstrative embodiments, docking controller 136 may download device-specific docking firmware 134 from device 130 to docking device 140 via wireless communication link 137.

In some demonstrative embodiments, docking controller 142 may receive the download of the device-specific docking firmware 134 via wireless communication link 137, for example, by utilizing basic firmware 147, e.g., as described above.

In some demonstrative embodiments, device-specific docking firmware 134 may control interaction between docking device 140 and mobile device 130 according to the configuration of mobile device 130, e.g., as described above.

In some demonstrative embodiments, docking controller 142 may replace device-specific docking firmware 114 with device-specific docking firmware 134, and may store device-specific docking firmware 134 in RAM 146. In other embodiments, docking controller 142 may maintain both device-specific docking firmware 114 and device-specific docking firmware 134 in RAM 146.

In some demonstrative embodiments, processor 191 of docking device 140 may execute device-specific docking firmware 134 to control the interaction between docking device 140 and mobile device 130.

In some demonstrative embodiments, downloading device-specific docking firmware 134 and/or device-specific docking firmware 114 may take a relatively reduced period of time, for example, if wireless communication links 107 and/or 137 have a relatively high throughput.

In some demonstrative embodiments, downloading device-specific docking firmware 134 and/or device-specific docking firmware 114 may enable upgrading a user experience (UX) with device 140 and peripherals 125, for example, by utilizing a current version and/or an upgraded version of device-specific docking firmware 114 or 134.

In some demonstrative embodiments, using device-specific docking firmware 134 and/or device-specific docking firmware 114 may enable upgrading and/or updating a device-specific docking firmware, for example, without modifying hardware components of device 140.

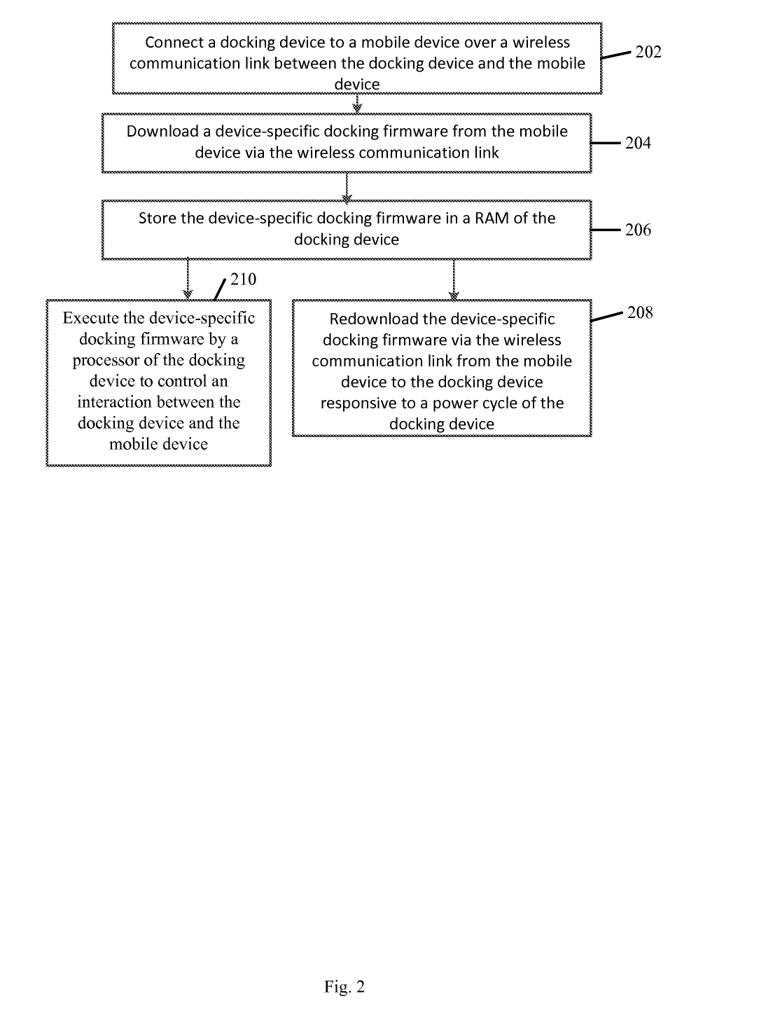

Reference is now made to FIG. 2, which schematically illustrates a method of downloading firmware from a mobile device to a docking device, in accordance with some demonstrative embodiments. For example, one or more of the operations of the method of FIG. 2 may be performed by a wireless communication system, e.g., system 100 (FIG. 1); a wireless docking device, e.g., device 140 (FIG. 1), a mobile device, e.g., devices 102 and/or 130 (FIG. 1); a docking controller, e.g., docking controller 112, 132 and/or 142 (FIG. 1); and/or a wireless communication unit, e.g., wireless communication unit 110 (FIG. 1), wireless communication unit 132 (FIG. 1), and/or wireless communication unit 142 (FIG. 1).

As indicated at block 202, the method may include connecting a docking device to a mobile device over a wireless communication link between the docking device and the mobile device. For example, docking controller 142 (FIG. 1) may connect docking device 140 (FIG. 1) to mobile device 102 (FIG. 1) over wireless communication link 107 (FIG. 1), e.g., as described above.

As indicated at block 204, the method may include downloading a device-specific docking firmware from the mobile device via the wireless communication link. The device-specific docking firmware may control interaction between the docking device and the mobile device according to a configuration of the mobile device. For example, docking controller 142 (FIG. 1) may download device-specific docking firmware 114 (FIG. 1) from mobile device 102 (FIG. 1), e.g., as described above.

As indicated at block 206, the method may include storing the device-specific docking firmware in a RAM of the docking device. For example, docking controller 142 (FIG. 1) may store device-specific docking firmware 114 (FIG. 1) in RAM 146 (FIG. 1), e.g., as described above.

As indicated at block 208, the method may include re-downloading the device-specific docking firmware via the wireless communication link from the mobile device to the docking device responsive to a power cycle of the docking device. For example, docking controller 142 (FIG. 1) may re-download device-specific docking firmware 114 (FIG. 1) responsive to a power cycle of docking device 140 (FIG. 1), e.g., as described above.

As indicated at block 210, the method may include executing the device-specific docking firmware by a processor of the docking device to control the interaction between the docking device and the mobile device. For example, processor 191 (FIG. 1) may execute device-specific docking firmware 114 (FIG. 1) to control the interaction between device 102 and device 140 (FIG. 1), e.g., as described above.

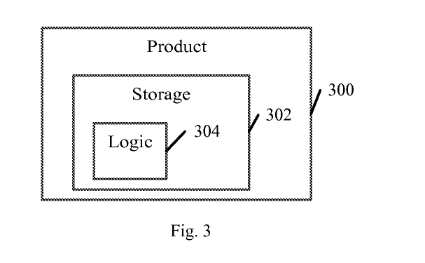

Reference is made to FIG. 3, which schematically illustrates a product of manufacture 300, in accordance with some demonstrative embodiments. Product 300 may include a non-transitory machine-readable storage medium 302 to store logic 304, which may be used, for example, to perform at least part of the functionality of mobile device 102 (FIG.

1), mobile device 130 (FIG. 1), docking device 140 (FIG. 1), wireless communication unit 110 (FIG. 1), wireless communication unit 142 (FIG. 1), wireless communication unit 130 (FIG. 1), docking controller 112 (FIG. 1), docking controller 136 (FIG. 1), docking controller 142 (FIG. 1), and/or to perform one or more operations of the method of FIG. 2. The phrase “non-transitory machine-readable medium” is directed to include all computer-readable media, with the sole exception being a transitory propagating signal.

In some demonstrative embodiments, product 300 and/or machine-readable storage medium 302 may include one or more types of computer-readable storage media capable of storing data, including volatile memory, non-volatile memory, removable or non-removable memory, erasable or non-erasable memory, writeable or re-writeable memory, and the like. For example, machine-readable storage medium 302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus comprising a docking controller to control a wireless communication unit of a mobile device to communicate with a docking device over a wireless communication link between the mobile device and the docking device, wherein the docking controller is to send a device-specific docking firmware from the mobile device to the docking device via the wireless communication link, the device-specific docking firmware is to control interaction between the docking device and the mobile device according to a configuration of the mobile device.

Example 2 includes the subject matter of Example 1, and optionally, wherein the device-specific docking firmware is to control at least one interaction attribute selected from the group consisting of a communication protocol to communicate between the mobile device and the docking device, a type of information to be communicated between the mobile device and the docking device, connection management of the wireless communication link, access management of the wireless communication link, time management of the wireless communication link, and power management of communication over the wireless communication link.

Example 3 includes the subject matter of Example 1 or 2, and optionally, wherein the docking controller is to re-send the device-specific docking firmware from the mobile device to the docking device responsive to a power cycle of the docking device.

Example 4 includes the subject matter of any one of Examples 1-3, and optionally, wherein the docking controller is to update the device-specific docking firmware based on an updated device-specific docking firmware received from a vendor of the mobile device.

Example 5 includes the subject matter of any one of Examples 1-4, and optionally, wherein the docking controller is to control the wireless communication unit to establish the wireless communication link between the mobile device and the docking device.

Example 6 includes the subject matter of any one of Examples 1-5, and optionally, wherein the wireless communication link comprises a millimeter-wave (mmwave) wireless communication link.

Example 7 includes the subject matter of any one of Examples 1-6, and optionally, wherein the wireless communication link comprises a peer-to-peer (P2P) communication link.

Example 8 includes an apparatus comprising a docking controller to connect a docking device to a mobile device over a wireless communication link between the docking device and the mobile device, and to receive a device-specific docking firmware from the mobile device via the wireless communication link, wherein the device-specific docking firmware is to control interaction between the docking device and the mobile device according to a configuration of the mobile device.

Example 9 includes the subject matter of Example 8, and optionally, wherein the docking controller is to connect the docking device to another mobile device over another wireless communication link between the docking device and the another mobile device, and to receive another device-specific docking firmware via the another wireless communication link from the another mobile device, wherein the another device-specific docking firmware is to control interaction between the docking device and the another mobile device according to a configuration of the another mobile device.

Example 10 includes the subject matter of Example 9, and optionally, wherein the docking controller is to connect to the another mobile device after disconnection of the docking device from the mobile device.

Example 11 includes the subject matter of Example 10, and optionally, wherein the docking controller is to replace the device-specific docking firmware with the another device-specific docking firmware.

Example 12 includes the subject matter of any one of Examples 8-11, and optionally, wherein the device-specific docking firmware is to control at least one interaction selected from the group consisting of a communication protocol to communicate between the docking device and the mobile device, a type of information to be communicated the docking device and the mobile device, connection management of the first wireless communication link, access management of the wireless communication link, time management of the wireless communication link and power management of the communication over the wireless communication link.

Example 13 includes the subject matter of any one of Examples 8-12, and optionally, wherein the docking controller is to store the device-specific docking firmware in a random access memory (RAM) of the docking device.

Example 14 includes the subject matter of Example 13, and optionally, wherein the docking controller is to remove the device-specific docking firmware from the RAM if the docking device disconnects from the mobile device.

Example 15 includes the subject matter of any one of Examples 8-14, and optionally, wherein the docking controller is to execute the device-specific docking firmware by a processor of the docking device to control the interaction between the docking device and the mobile device.

Example 16 includes the subject matter of any one of Examples 8-15, and optionally, wherein the docking controller is to receive the device-specific docking firmware via the wireless communication link from the mobile device to the docking device responsive to a power cycle of the docking device.

Example 17 includes the subject matter of any one of Examples 8-16, and optionally, wherein the docking controller is to control a wireless communication unit of the docking device to establish the wireless communication link between the docking device and the mobile device.

Example 18 includes the subject matter of any one of Examples 8-17, and optionally, wherein the wireless communication link comprises a millimeter-wave (mmwave) wireless communication link.

Example 19 includes the subject matter of any one of Examples 8-18, and optionally, wherein the wireless communication link comprises a peer-to-peer (P2P) communication link.

Example 20 includes a mobile device comprising at least one antenna; a storage to store a device-specific docking firmware; a wireless communication unit; and a docking controller to control the wireless communication unit to communicate with a docking device over a wireless communication link between the mobile device and the docking device, wherein the docking controller is to send the device-specific docking firmware from the mobile device to the docking device via the wireless communication link, the device-specific docking firmware is to control interaction between the docking device and the mobile device according to a configuration of the mobile device.

Example 21 includes the subject matter of Example 20, and optionally, wherein the device-specific docking firmware is to control at least one interaction attribute selected from the group consisting of a communication protocol to communicate between the mobile device and the docking device, a type of information to be communicated between the mobile device and the docking device, connection management of the wireless communication link, access management of the wireless communication link, time management of the wireless communication link, and power management of communication over the wireless communication link.

Example 22 includes the subject matter of Example 20 or 21, and optionally, wherein the docking controller is to re-send the device-specific docking firmware from the mobile device to the docking device responsive to a power cycle of the docking device.

Example 23 includes the subject matter of any one of Examples 20-22, and optionally, wherein the docking controller is to update the device-specific docking firmware based on an updated device-specific docking firmware received from a vendor of the mobile device.

Example 24 includes the subject matter of any one of Examples 20-23, and optionally, wherein the docking controller is to control the wireless communication unit to establish the wireless communication link between the mobile device and the docking device.

Example 25 includes the subject matter of any one of Examples 20-24, and optionally, wherein the wireless communication link comprises a millimeter-wave (mmwave) wireless communication link.

Example 26 includes the subject matter of any one of Examples 20-25, and optionally, wherein the wireless communication link comprises a peer-to-peer (P2P) communication link.

Example 27 includes a docking device comprising at least one antenna; a wireless communication unit; and a docking controller to control the wireless communication unit to connect the docking device to a mobile device over a wireless communication link between the docking device and the mobile device, and to receive a device-specific docking firmware from the mobile device via the wireless communication link, wherein the device-specific docking firmware is to control interaction between the docking device and the mobile device according to a configuration of the mobile device.

Example 28 includes the subject matter of Example 27, and optionally, wherein the docking controller is to connect the docking device to another mobile device over another wireless communication link between the docking device and the another mobile device, and to receive another device-specific docking firmware via the another wireless communication link from the another mobile device, wherein the another device-specific docking firmware is to control interaction between the docking device and the another mobile device according to a configuration of the another mobile device.

Example 29 includes the subject matter of Example 28, and optionally, wherein the docking controller is to connect to the another mobile device after disconnection of the docking device from the mobile device.

Example 30 includes the subject matter of Example 29, and optionally, wherein the docking controller is to replace the device-specific docking firmware with the another device-specific docking firmware.

Example 31 includes the subject matter of any one of Examples 27-30, and optionally, wherein the device-specific docking firmware is to control at least one interaction selected from the group consisting of a communication protocol to communicate between the docking device and the mobile device, a type of information to be communicated the docking device and the mobile device, connection management of the first wireless communication link, access management of the wireless communication link, time management of the wireless communication link and power management of the communication over the wireless communication link.

Example 32 includes the subject matter of any one of Examples 27-31, and optionally, wherein the docking controller is to store the device-specific docking firmware in a random access memory (RAM) of the docking device.

Example 33 includes the subject matter of Example 32, and optionally, wherein the docking controller is to remove the device-specific docking firmware from the RAM if the docking device disconnects from the mobile device.

Example 34 includes the subject matter of any one of Examples 27-33, and optionally, wherein the docking controller is to execute the device-specific docking firmware by a processor of the docking device to control the interaction between the docking device and the mobile device.

Example 35 includes the subject matter of any one of Examples 27-34, and optionally, wherein the docking controller is to receive the device-specific docking firmware via the wireless communication link from the mobile device to the docking device responsive to a power cycle of the docking device.

Example 36 includes the subject matter of any one of Examples 27-35, and optionally, wherein the docking controller is to control a wireless communication unit of the docking device to establish the wireless communication link between the docking device and the mobile device.

Example 37 includes the subject matter of any one of Examples 27-36, and optionally, wherein the wireless communication link comprises a millimeter-wave (mmwave) wireless communication link.

Example 38 includes the subject matter of any one of Examples 27-37, and optionally, wherein the wireless communication link comprises a peer-to-peer (P2P) communication link.

Example 39 includes a method performed at a mobile device or a docking device, the method comprising establishing a wireless communication link between the mobile device and the docking device; and downloading a device-specific docking firmware from the mobile device to the docking device via the wireless communication link, the device-specific docking firmware is to control interaction between the docking device and the mobile device according to a configuration of the mobile device.

Example 40 includes the subject matter of Example 39, and optionally, wherein the device-specific docking firmware is to control at least one interaction attribute selected from the group consisting of a communication protocol to communicate between the mobile device and the docking device, a type of information to be communicated between the mobile device and the docking device, connection management of the wireless communication link, access management of the wireless communication link, time management of the wireless communication link, and power management of communication over the wireless communication link.

Example 41 includes the subject matter of Example 39 or 40 and optionally, comprising re-downloading the device-specific docking firmware from the mobile device to the docking device responsive to a power cycle of the docking device.

Example 42 includes the subject matter of any one of Examples 39-41 and optionally, comprising updating the device-specific docking firmware at the mobile device based on an updated device-specific docking firmware received from a vendor of the mobile device.

Example 43 includes the subject matter of any one of Examples 39-41 and optionally, comprising connecting the docking device to another mobile device over another wireless communication link between the docking device and the another mobile device; downloading another device-specific docking firmware via the another wireless communication link from the another mobile device; and controlling interaction between the docking device and the another mobile device according to a configuration of the another mobile device.

Example 44 includes the subject matter of Example 43 and optionally, comprising connecting to the another mobile device after disconnection of the docking device from the mobile device.

Example 45 includes the subject matter of Example 43 or 44 and optionally, comprising replacing the device-specific docking firmware with the another device-specific docking firmware.

Example 46 includes the subject matter of any one of Examples 39-41 and optionally, comprising storing the device-specific docking firmware in a random access memory (RAM) of the docking device.

Example 47 includes the subject matter of Example 46 and optionally, comprising removing the device-specific docking firmware from the RAM if the docking device disconnects from the mobile device.

Example 48 includes the subject matter of any one of Examples 39-41 and optionally, comprising executing the device-specific docking firmware by a processor of the docking device to control the interaction between the docking device and the mobile device.

Example 49 includes the subject matter of any one of Examples 39-48, and optionally, wherein the wireless communication link comprises a millimeter-wave (mmwave) wireless communication link.

Example 50 includes the subject matter of any one of Examples 39-48, and optionally, wherein the wireless communication link comprises a peer-to-peer (P2P) communication link.

Example 51 includes a product including a non-transitory storage medium having stored thereon instructions that, when executed by a machine, result in establishing a wireless communication link between a mobile device and a docking device; and downloading a device-specific docking firmware from the mobile device to the docking device via the wireless communication link, the device-specific docking firmware is to control interaction between the docking device and the mobile device according to a configuration of the mobile device.

Example 52 includes the subject matter of Example 51, and optionally, wherein the device-specific docking firmware is to control at least one interaction attribute selected from the group consisting of a communication protocol to communicate between the mobile device and the docking device, a type of information to be communicated between the mobile device and the docking device, connection management of the wireless communication link, access management of the wireless communication link, time management of the wireless communication link, and power management of communication over the wireless communication link.

Example 53 includes the subject matter of Example 51 or 52, and optionally, wherein the instructions result in re-downloading the device-specific docking firmware from the mobile device to the docking device responsive to a power cycle of the docking device.

Example 54 includes the subject matter of any one of Examples 51-53, and optionally, wherein the instructions result in updating the device-specific docking firmware at the mobile device based on an updated device-specific docking firmware received from a vendor of the mobile device.

Example 55 includes the subject matter of any one of Examples 51-53, and optionally, wherein the instructions result in connecting the docking device to another mobile device over another wireless communication link between the docking device and the another mobile device; downloading another device-specific docking firmware via the another wireless communication link from the another mobile device; and controlling interaction between the docking device and the another mobile device according to a configuration of the another mobile device.

Example 56 includes the subject matter of Example 55, and optionally, wherein the instructions result in connecting to the another mobile device after disconnection of the docking device from the mobile device.

Example 57 includes the subject matter of Example 55 or 56, and optionally, wherein the instructions result in replacing the device-specific docking firmware with the another device-specific docking firmware.

Example 58 includes the subject matter of any one of Examples 51-53, and optionally, wherein the instructions result in storing the device-specific docking firmware in a random access memory (RAM) of the docking device.

Example 59 includes the subject matter of Example 58, and optionally, wherein the instructions result in removing the device-specific docking firmware from the RAM if the docking device disconnects from the mobile device.

Example 60 includes the subject matter of any one of Examples 51-53, and optionally, wherein the instructions result in executing the device-specific docking firmware by a processor of the docking device to control the interaction between the docking device and the mobile device.

Example 61 includes the subject matter of any one of Examples 51-60, and optionally, wherein the wireless communication link comprises a millimeter-wave (mmwave) wireless communication link.

Example 62 includes the subject matter of any one of Examples 51-61, and optionally, wherein the wireless communication link comprises a peer-to-peer (P2P) communication link.

Example 63 includes an apparatus comprising means for establishing a wireless communication link between a mobile device and a docking device; and means for downloading a device-specific docking firmware from the mobile device to the docking device via the wireless communication link, the device-specific docking firmware is to control interaction between the docking device and the mobile device according to a configuration of the mobile device.

Example 64 includes the subject matter of Example 63, and optionally, wherein the device-specific docking firmware is to control at least one interaction attribute selected from the group consisting of a communication protocol to communicate between the mobile device and the docking device, a type of information to be communicated between the mobile device and the docking device, connection management of the wireless communication link, access management of the wireless communication link, time management of the wireless communication link, and power management of communication over the wireless communication link.

Example 65 includes the subject matter of Example 63 or 64 and optionally, comprising means for re-downloading the device-specific docking firmware from the mobile device to the docking device responsive to a power cycle of the docking device.

Example 66 includes the subject matter of any one of Examples 63-65 and optionally, comprising means for updating the device-specific docking firmware at the mobile device based on an updated device-specific docking firmware received from a vendor of the mobile device.

Example 67 includes the subject matter of any one of Examples 63-65 and optionally, comprising means for connecting the docking device to another mobile device over another wireless communication link between the docking device and the another mobile device; means for downloading another device-specific docking firmware via the another wireless communication link from the another mobile device; and means for controlling interaction between the docking device and the another mobile device according to a configuration of the another mobile device.

Example 68 includes the subject matter of Example 67 and optionally, comprising connecting to the another mobile device after disconnection of the docking device from the mobile device.

Example 69 includes the subject matter of Example 67 or 68 and optionally, comprising means for replacing the device-specific docking firmware with the another device-specific docking firmware.

Example 70 includes the subject matter of any one of Examples 63-65 and optionally, comprising means for storing the device-specific docking firmware in a random access memory (RAM) of the docking device.

Example 71 includes the subject matter of Example 70 and optionally, comprising means for removing the device-specific docking firmware from the RAM if the docking device disconnects from the mobile device.

Example 72 includes the subject matter of any one of Examples 63-65 and optionally, comprising means for executing the device-specific docking firmware by a processor of the docking device to control the interaction between the docking device and the mobile device.

Example 73 includes the subject matter of any one of Examples 63-72, and optionally, wherein the wireless communication link comprises a millimeter-wave (mmwave) wireless communication link.

Example 74 includes the subject matter of any one of Examples 63-73, and optionally, wherein the wireless communication link comprises a peer-to-peer (P2P) communication link.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

1.-25. (canceled)

26. An apparatus comprising:
a docking controller to control a wireless communication unit of a mobile device to communicate with a docking device over a wireless communication link between said mobile device and said docking device, wherein said docking controller is to send a device-specific docking firmware from said mobile device to said docking device via said wireless communication link, said device-specific docking firmware is to control interaction between said docking device and said mobile device according to a configuration of said mobile device.

27. The apparatus of claim 26, wherein said device-specific docking firmware is to control at least one interaction attribute selected from the group consisting of a communication protocol to communicate between said mobile device and said docking device, a type of information to be communicated between said mobile device and said docking device, connection management of said wireless communication link, access management of said wireless communication link, time management of said wireless communication link, and power management of communication over said wireless communication link.

28. The apparatus of claim 26, wherein said docking controller is to re-send said device-specific docking firmware from said mobile device to said docking device responsive to a power cycle of said docking device.

29. The apparatus of claim 26, wherein said docking controller is to update said device-specific docking firmware based on an updated device-specific docking firmware received from a vendor of said mobile device.

30. The apparatus of claim 26, wherein said docking controller is to control said wireless communication unit to establish said wireless communication link between said mobile device and said docking device.

31. The apparatus of claim 26, wherein said wireless communication link comprises a millimeter-wave (mmwave) wireless communication link.

32. The apparatus of claim 26, wherein said wireless communication link comprises a peer-to-peer (P2P) communication link.

33. The apparatus of claim 26 comprising said mobile device, the mobile device including at least one antenna, a process, an input unit and an output unit.

34. An apparatus comprising:
a docking controller to connect a docking device to a mobile device over a wireless communication link between said docking device and said mobile device, and to receive a device-specific docking firmware from said mobile device via said wireless communication link, wherein said device-specific docking firmware is to control interaction between said docking device and said mobile device according to a configuration of said mobile device.

35. The apparatus of claim 34, wherein said docking controller is to connect said docking device to another mobile device over another wireless communication link between said docking device and said another mobile device, and to receive another device-specific docking firmware via said another wireless communication link from said another mobile device, wherein said another device-specific docking firmware is to control interaction between said docking device and said another mobile device according to a configuration of said another mobile device.

36. The apparatus of claim 35, wherein said docking controller is to connect to said another mobile device after disconnection of said docking device from said mobile device.

37. The apparatus of claim 35, wherein said docking controller is to replace said device-specific docking firmware with said another device-specific docking firmware.

38. The apparatus of claim 34, wherein said docking controller is to store said device-specific docking firmware in a random access memory (RAM) of said docking device.

39. The apparatus of claim 34 comprising said docking device, the docking device including at least one antenna, and a wireless communication unit.

40. A method to be performed at a mobile device or a docking device, the method comprising:
establishing a wireless communication link between the mobile device and the docking device; and
downloading a device-specific docking firmware from said mobile device to said docking device via said wireless communication link, said device-specific docking firmware is to control interaction between said docking device and said mobile device according to a configuration of said mobile device.

41. The method of claim 40, wherein said device-specific docking firmware is to control at least one interaction attribute selected from the group consisting of a communication protocol to communicate between said mobile device and said docking device, a type of information to be communicated between said mobile device and said docking device, connection management of said wireless communication link, access management of said wireless communication link, time management of said wireless communication link, and power management of communication over said wireless communication link.

42. The method of claim 40 comprising re-downloading said device-specific docking firmware from said mobile device to said docking device responsive to a power cycle of said docking device.

43. The method of claim 40 comprising updating said device-specific docking firmware at said mobile device based on an updated device-specific docking firmware received from a vendor of said mobile device.

44. The method of claim 40 comprising:
connecting said docking device to another mobile device over another wireless communication link between said docking device and said another mobile device;
downloading another device-specific docking firmware via said another wireless communication link from said another mobile device; and
controlling interaction between said docking device and said another mobile device according to a configuration of said another mobile device.

45. The method of claim 40, wherein said wireless communication link comprises a millimeter-wave (mmwave) wireless communication link.

46. A product including a non-transitory storage medium having stored thereon instructions that, when executed by a machine, result in:
establishing a wireless communication link between a mobile device and a docking device; and
downloading a device-specific docking firmware from said mobile device to said docking device via said wireless communication link, said device-specific docking firmware is to control interaction between said docking device and said mobile device according to a configuration of said mobile device.

47. The product of claim 46, wherein said device-specific docking firmware is to control at least one interaction attribute selected from the group consisting of a communication protocol to communicate between said mobile device and said docking device, a type of information to be communicated between said mobile device and said docking device, connection management of said wireless communication link, access management of said wireless communication link, time management of said wireless communication link, and power management of communication over said wireless communication link.

48. The product of claim 46, wherein said instructions result in updating said device-specific docking firmware at said mobile device based on an updated device-specific docking firmware received from a vendor of said mobile device.

49. The product of claim 46, wherein said instructions result in:
connecting said docking device to another mobile device over another wireless communication link between said docking device and said another mobile device;
downloading another device-specific docking firmware via said another wireless communication link from said another mobile device; and
controlling interaction between said docking device and said another mobile device according to a configuration of said another mobile device.

50. The product of claim 49, wherein said instructions result in connecting to said another mobile device after disconnection of said docking device from said mobile device.
